(19) United States
(12) Patent Application Publication
(10) Pub. No.: US 2022/0134494 A1
(43) Pub. Date: May 5, 2022

(54) Hose Coupler

(71) Applicant: Sandblast Solutions, Inc., Millstone Township, NJ (US)

(72) Inventor: Marek Ochrymowicz, Harrison, NJ (US)

(73) Assignee: Sandblast Solutions, Inc., Millstone Township, NJ (US)

(21) Appl. No.: 17/090,026

(22) Filed: Nov. 5, 2020

(51) Int. Cl. B23P 19/02

(52) U.S. Cl. CPC B23P 19/02; F16L 37/244

(57) ABSTRACT

A system for installing hose couplings includes a motor, a drive shaft extending along and axis and powered about the axis by the motor, and a tool rotationally coupled to the drive shaft. The tool includes a hub and two arms extending outward from the hub and defining respective load surfaces such that both arms may tangentially abut a respective hook of a quick coupling for a blast hose when the quick coupling is aligned on the axis.

### BACKGROUND OF THE INVENTION

A known variety of couplings for sand blast hoses is referred to as a quick coupling, or a “claw” coupling, because such couplings include hooks that resemble claws extending beyond their ends for quick interlocking. Such couplings typically include two L-shaped tracks between the hooks, and a radially interior face of each hook includes a recess for receiving a lip that defines the L-shaped track. Thus, two hoses with quick couplings can be connected by sliding the hooks of each coupling into the tracks of the other, and turning one of the couplings clockwise relative to the other.

Such couplings include a collar portion for sliding over an end of the hose. The collar portion terminates at an annular internal shelf within the coupling that has an internal diameter intended to equal the internal diameter of the hose. Seating the hose against the shelf therefore creates a smooth, continuous cylindrical shape for the path of the sand. The smooth interior of the hose and coupling assembly is important because, due to the abrasive nature of sand and high air pressures used for sand blasting, any gaps or exposed edges will result in loosening or degradation of the hose and coupling, which will lead inevitably to leaks.

To avoid the loss of internal continuity provided by proper seating of the hose against the shelf, quick couplings are designed to prevent their displacement relative to the hose. In addition to including holes to accept screws to be driven into the hose, the collar portion of quick couplings prevents displacement by having a tight fit to hoses of corresponding diameter, and in some instances by including internal ribs or threads.

Because of the tight fit to the hose and the internal threading, manually installing a quick coupling on an end of a hose requires considerable effort. To install a quick coupling to a hose, a worker typically holds a squared-off end of the hose in one hand and the quick coupling in the other, then presses the collar portion onto the end of the hose. The worker must then turn the coupling several times while continuing to press the coupling on the coupling onto the end of the hose to guide the collar portion over the hose until the squared-off end reaches the internal shelf. The need to manually twist and press the collar during this process can fatigue the worker, limit the rate that couplings can be installed, and make proper seating of the end of the hose against the shelf difficult.

### BRIEF SUMMARY OF THE INVENTION

A tool may be used to transfer torque to a hose coupling while the hose coupling is installed on a hose. The tool may be connected to a motorized source of torque. The motorized source of torque may be a drive shaft which may be connected to a motor through a transmission. A jaw coupling may be connected to the drive shaft to engage with the tool.

The tool may include features for engaging the two hooks of the hose coupling. The features may be two arms extending radially outward from a hub of the tool. The two arms may include load bearing faces that are symmetrical about a central axis of rotation of the tool. The tool may also include a feature for aligning the hose coupling along the central axis of rotation. The aligning feature may be a boss sized to fit within an opening of the hose coupling. The aligning feature may alternatively be an extension of the hub or a disc sized to fit within the opening of the hose coupling. A bore may extend through the hub. A keyway may extend along the bore.

In another aspect, a system for installing hose couplings may include a motor, a drive shaft extending along and axis and powered about the axis by the motor, and a tool rotationally coupled to the drive shaft. The tool may include a hub and two arms extending outward from the hub and defining respective load surfaces such that both arms may tangentially abut a respective hook of a quick coupling for a blast hose when the quick coupling is aligned on the axis.

In some arrangements, the system may include a gear reduction between the motor and the drive shaft.

In some arrangements, the tool may be rotationally coupled to the drive shaft through a jaw coupling into which the drive shaft extends.

In some arrangements, the tool may include an extension that can constrain the hose coupling onto the axis.

In some arrangements, the extension may be a boss with an external diameter smaller than an external diameter of the hub.

In some arrangements, the load surfaces may be symmetrical about a point on the axis on a plane perpendicular to the axis that intersects the arms.

In some arrangements, the load surfaces may be collinear on any plane perpendicular to the axis.

In another aspect, a tool for installing hose couplings may include a hub centered on an axis, and two arms extending radially outward from the hub, each including a load surface. The two load surfaces may be symmetrical to one another about a point on the axis on a plane perpendicular to the axis that intersects the arms. The tool may further include at least two torque coupling surfaces integrally formed with the hub, distinct from the load surfaces, and arranged relative to the axis such that torque about the axis may be imparted to the hub by simultaneous application of force to the torque coupling surfaces.

In some arrangements, the tool may include teeth extending axially from the hub and defining the torque coupling surfaces.

In some arrangements, the teeth may be three teeth for engagement with a jaw coupling.

In some arrangements, the tool may include an axial extension from the hub that can constrain a hose coupling onto the axis.

In some arrangements, the torque coupling surfaces may be defined on features extending in an opposite axial direction from the hub than the extension.

In some arrangements, the extension may be a boss having a smaller external diameter than an external diameter of the hub.

In some arrangements, the tool may include an axial bore extending through the hub.

In another aspect, a method of installing a hose coupling onto a hose may include pressing the hose into a hose receiving end of the house coupling while a motorized source of torque rotates the hose coupling.

In some arrangements, the hose coupling may be rotationally driven by the motorized source of torque through a drive shaft driven by the motorized source of torque and a tool rotationally coupling the hose coupling to the drive shaft. The tool may include a hub, and two arms extending outward from the hub and defining respective load surfaces such that both arms may tangentially abut a respective hook of a quick coupling for a blast hose when the quick coupling is aligned on the axis.

In some arrangements, the method may include coupling teeth of the tool to a jaw coupling rotationally coupled to the drive shaft before pressing the hose into the hose receiving portion of the hose coupling.

In some arrangements, aligning the hose coupling on an axis of rotation of the drive shaft and positioning the hose coupling relative to the tool such that the arms each abut a hook extending from the hose coupling.

In some arrangements, the step of aligning the hose coupling on the axis may include sliding the hose coupling onto an extension from the hub.

In some arrangements, the extension from the hub may be a boss having an external diameter that is less than an external diameter of the hub.

### BRIEF DESCRIPTION OF THE DRAWINGS

FIG. 1A is a perspective view of a tool according to an aspect of the disclosure.

FIGS. 1B and 1C are top and bottom plan views, respectively, of the tool of FIG. 1A.

FIG. 2 is a perspective view of a drive assembly that may be used with the tool of FIG. 1A.

FIGS. 3A and 3B are schematic representations of an arrangement in different stages of installing a coupling on a hose.

FIGS. 4A and 4B are cross-sectional views of a portion of the arrangement of

FIGS. 2A and 2B in different stages of installing the coupling on the hose.

FIG. 5 is a block diagram of a process of installing the coupling on the hose.

FIG. 6A is a perspective view of a tool according to another aspect of the disclosure.

FIGS. 6B and 6C are top and bottom plan views, respectively, of the tool of FIG. 6A.

### DETAILED DESCRIPTION

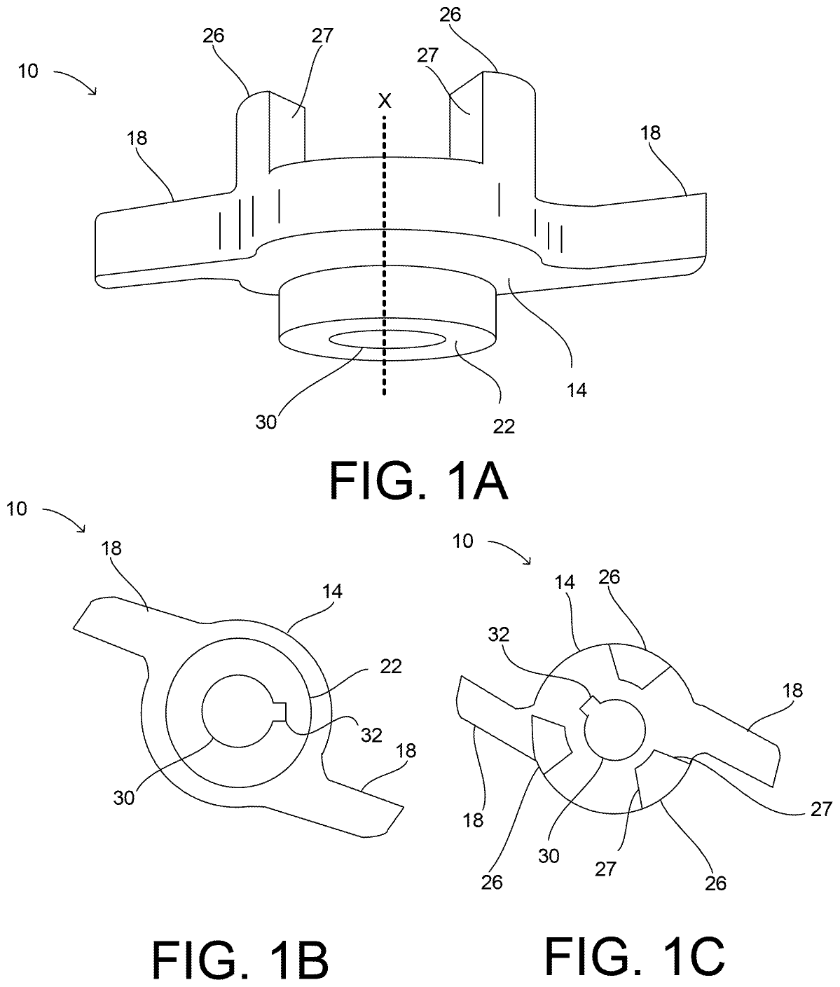

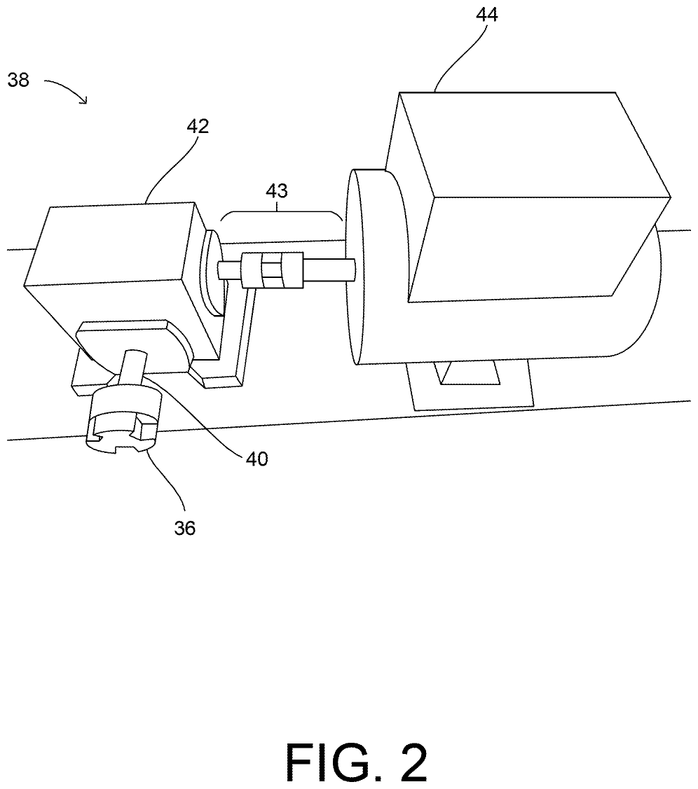

A tool 10 for rotationally driving a quick coupling during installation of the coupling onto a blasting hose is shown in FIGS. 1A-1C. The tool 10 includes a hub 14 that is generally in the shape of a circular disc centered on an axis X and disposed on a plane perpendicular to the axis X. Two arms 18 extend radially outward from the hub 14 and on the plane of the hub 14. In the illustrated arrangement, both arms 18 extend at an angle that is between normal and tangent to their respective locations on the perimeter of the hub 14, enabling the arms 18 to hook around the hooks or claws of a quick connect coupling when in use. However, in other arrangements, the arms 18 can extend at any angle that enables them to cooperatively apply torque to a quick coupling by abutting the quick coupling's hooks. The arms 18 are both symmetrical about a point on the axis X on every plane perpendicular to the axis X that intersects the arms 18. As such, load bearing faces of the arms 18 will contact the hooks of a hose coupling at the same time if the hose coupling is disposed along the axis X. In the illustrated example, the arms 18 do not extend in purely radial directions relative to the axis X. Thus, the load bearing surfaces of the arms 18, referring to the surfaces of the arms that may circumferentially abut hooks of a hose coupling aligned on the axis X, are parallel but not collinear on any plane perpendicular to the axis X. Extension of the arms 18 at equal angles that are not purely radial relative to the axis X, such as the angles illustrated in FIGS. 1A-1C, will act to center the quick coupling on the axis X during use of the tool, as the hooks will tend to slide along the arms 18 until they reach equal distances from the axis X. However, in other arrangements, the arms 18 extend radially outward from the axis X.

A circular boss 22, also centered on the axis X, extends along the axis X from a face the hub 14. The boss 22 fits closely inside a gasket or opening opposite the collar portion of quick couplings of the size intended for the tool 10. Teeth 26 for a jaw coupling extend axially from an opposite side of the hub 14 from the boss 22. The illustrated arrangement of the tool 10 includes three teeth 26, but other arrangements include more or fewer teeth 26 as appropriate to fit available jaw couplings. The tool 10 of the illustrated arrangement also includes a cylindrical bore 30 centered on the axis X, and a keyway 32 extending radially from the bore 30, though alternative arrangements lack bore 30 and keyway 32. The tool 10 may therefore be coupled directly to a drive shaft with a key.

The teeth 26 as a group and the keyway 32 in cooperation with the bore 30 both provide torque coupling surfaces integral with the hub 14. It is possible to drive the tool 10 about the axis X by simultaneous application of force to at least two of the torque coupling surfaces at the same time. For example, each of the teeth 26 includes two opposed radial surfaces 27, and a pure moment on the tool 10 can be created about the axis X by simultaneous application of force to one of the radial surfaces of each of the teeth 26. Similarly, a moment about the axis X can be created by a key applying force to either lateral face of the keyway 32 while a drive shaft applies force to an interior surface of the bore 30.

The tool 10 can be made from any material strong enough to transfer torque from a motorized drive shaft to a hose coupling while the hose coupling is being installed on a hose. Suitable materials include, for example, metals, such as steel and steel alloys.

With the teeth 26, the tool 10 can be fitted to a jaw coupling 36 at the end of a drive shaft 40 in a drive assembly, such as the drive assembly 38 illustrated in FIG. 2, to enable the drive shaft 40 to power the tool 10 to rotate about the axis X. The teeth 26 of various arrangements differ in size such that a spider (not illustrated) may or may not be necessary to couple the tool 10 to the jaw coupling 36. In various arrangements, the drive shaft 40 and a corresponding key may or may not extend through the jaw coupling 36 into the bore 30 and keyway 32 of the tool 10 to maintain alignment of the tool 10 to jaw coupling 36. The drive shaft 40 is rotationally powered by a motor 44. The motor 44 of the illustrated example is a single phase brushless, or electrically commutated, motor, which can supply suitable torque for the process of installing a hose coupling described below. However, in other arrangements, three phase brushless motors, conventionally commutated motors, or any source of torque as may be appropriate for a given application are used. For example, a more powerful source of torque may be useful to turn the tool 10 with more force and at greater speed if axial force is supplied by a machine instead of by hand. Moreover, in the illustrated example, the motor 44 is separated from the drive shaft 40 by a transmission 42, with a coupling group 43 connecting the output shaft of the motor 44 to the input shaft of the transmission 42. In the illustrated example, the transmission 42 is a right angle worm gear speed reducer. However, the transmission 42 may be any number or kind of transmissions and gear assemblies. Further, in other examples, the motor 44 may output directly to the drive shaft 40 without a transmission 42.

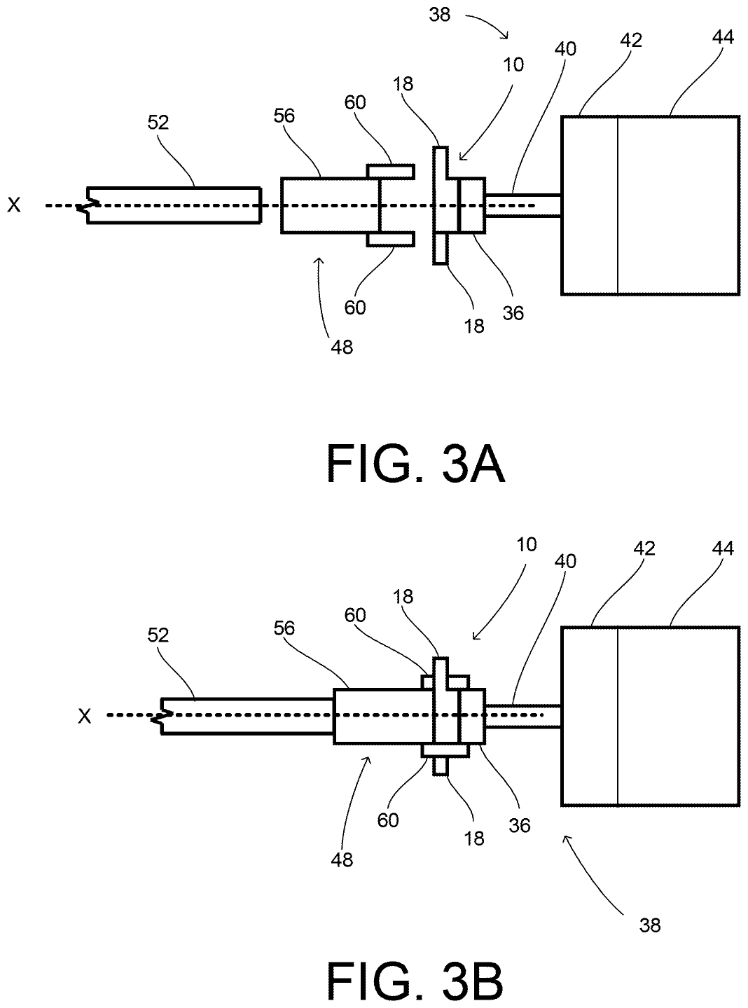

Referring to FIG. 3A, a hose coupling 48 of the quick coupling or jaw coupling variety described above may be arranged between a hose 52 and the tool 10. The hose coupling 48 includes a collar portion 56, which may be internally threaded, and two hooks 60 extending beyond an end of the hose coupling 48 opposite the collar portion 56. A portion of the hose 52 may be cut perpendicular to the length of the hose 52 to produce a squared off end as shown in FIG. 3A.

To begin a process of installing the hose coupling 48 on the squared off free end of the hose 52, the hose coupling 48 may be engaged to the tool 10 as shown in FIG. 3B. To engage the hose coupling 48 to the tool 10, the hooks 60 are placed between the arms 18, the hose coupling 48 is aligned on the axis X, and the boss 22 is placed into the end of the hose coupling 48 opposite from the collar portion 56. Either or both of the hose coupling 48 and tool 18 are rotated about the axis X about the other until the hooks 60 abut the arms 18, enabling transmission of torque about the axis X to the hose coupling 48 through a moment force coupling provided by action of the arms 18 in parallel, opposite directions on the hooks 60. With the hose coupling 48 engaged to the tool 10, the free end of the hose 52 is pressed to an opening of the collar portion 56. The motor 44 may be activated at any stage of the process, but it is safer and thus specifically contemplated to activate the motor 44 after the hose coupling 48 is engaged to the tool 10. More specifically, the motor 44 may be activated while the free end of the hose 52 is pressed to the opening of the collar portion 56.

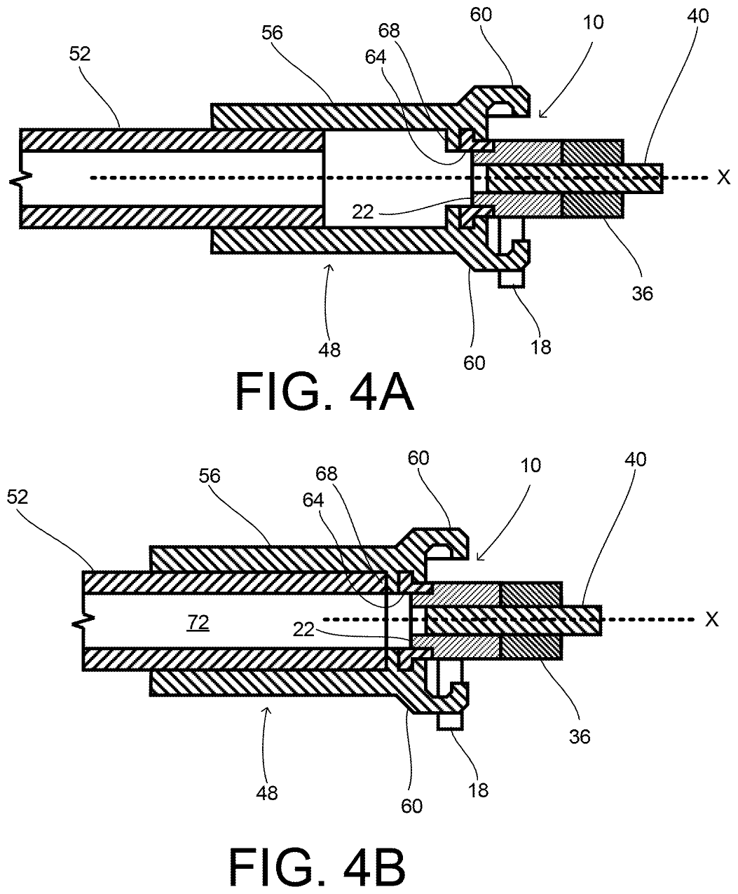

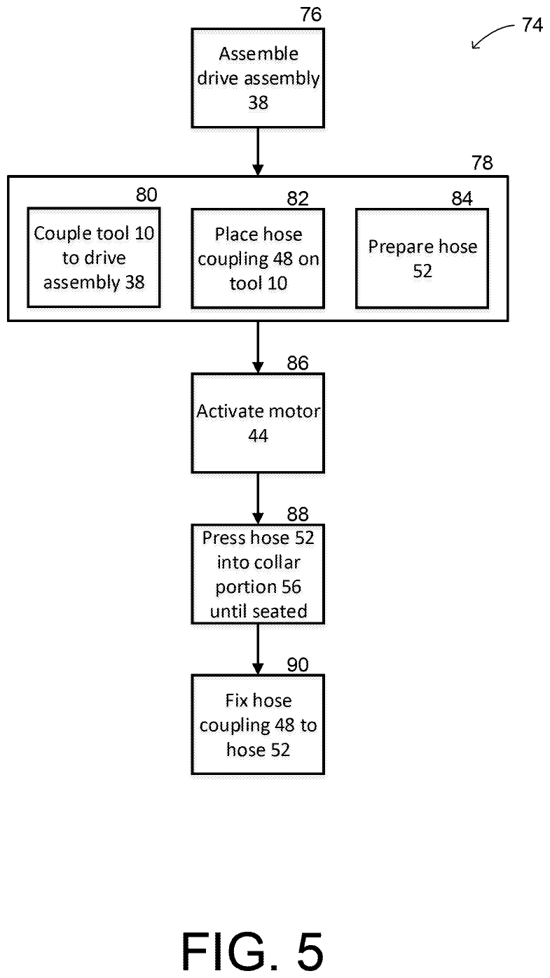

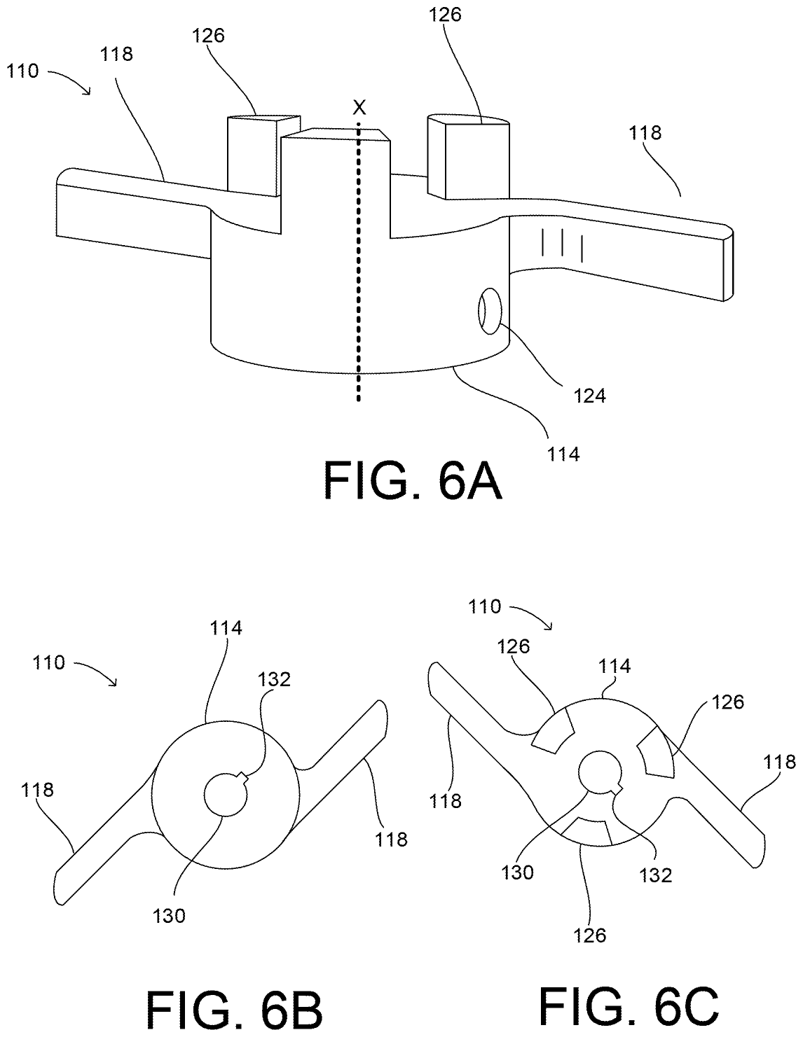

Engagement of the hose coupling 48 to the tool 10 and the tool 10 to the jaw coupling 36 and drive shaft 40 is shown in more detail in FIG. 4A. The hose coupling 48 is aligned on the axis X of the tool 10, as is the jaw coupling 36 and the drive shaft 40. The hose coupling 48 of the illustrated arrangement is fitted with a gasket 64, and the boss 22 of the tool 10 extends into the gasket 64. In other arrangements, the boss 22 fits directly into the hose coupling 48 without a gasket 64. An external diameter of the boss 22 matches an internal diameter of the hose coupling 48 to constrain the hose coupling 48 onto the axis X. Thus, the boss 22 fits within the hose coupling 48, or the gasket 64 specifically, with little or no space around the external diameter of the boss 22. The matching between the diameters may be a slight interference fit between the boss 22 and the hose coupling 48, particularly where the boss 22 fits into the gasket 64.

Each of the arms 18, only one of which is visible from the perspective of FIGS. 4A and 4B, abuts one of the hooks 60. Though not illustrated in FIGS. 4A and 4B, the teeth 26 of the tool 10 interlock with corresponding teeth of the jaw coupling 40, possibly with a spider disposed between the teeth 26 and the jaw coupling 36.

In the illustrated arrangement, the drive shaft 40 extends into the bore 30 of the tool 10, and a corresponding key, not illustrated, extends into the keyway 32. In other arrangements, the key alone or the key and the drive shaft 40 do not extend into the tool 10. For example, in some arrangements, the tool 10 is coupled to the jaw coupling 36 with a spider that lacks a central hole. In such arrangements, the drive shaft 40 and key extend into the jaw coupling 36, but not the tool 10. In further alternative arrangements, the tool 10 could be placed directly on the drive shaft 40, and no jaw coupling 36 is used.

Continuing the process of installing the hose coupling, the worker pushes the free end of the hose 52 into the opening of the collar portion 56 as shown in FIG. 4A while the hose coupling 48 rotates about the axis X under the power of the motor 40. The motor 40, in cooperation with any gearing or other transmission, may be configured to cause the hose coupling 48 to turn at any speed that the worker finds useful. All speeds in the range of 20 to 60 rotations per minute (RPM) are contemplated, though speeds outside that range may be used if the worker prefers. Because the tool 10 enables continuous transfer of torque from the motor 44, omitted from FIGS. 4A and 4B, to the hose coupling 48, no torque needs to be applied to the hose coupling 48 manually. Instead, a worker only needs to prevent the hose 52 from twisting while pushing the free end of the hose 52 into the opening of the collar portion 56 as the hose coupling 48 turns. The weight and resilience of the hose 52, which is likely to be constructed of thick rubber or similar compounds for sandblasting applications, contribute to preventing the hose 52 from twisting. As such, the worker is able to devote a relatively large portion of his or her efforts to applying axial force to the hose 52. Further, as long as the hose 52 is prevented from twisting to follow the hose coupling 48, the collar portion 56 will be in motion across the outer surface of the hose 52. Travel of the hose 52 within the collar portion 56 will therefore only be resisted by kinetic friction, so the worker will not need to repeatedly overcome static friction between turns of the wrist as is typical during purely manual installation methods. Use of the tool 10 to apply motorized torque to the hose coupling 48 instead of installing the hose coupling 48 manually thus has the potential to save the worker time and energy.

The hose 52 is completely inserted in the hose coupling 56 when the free end of the hose 52 seats against an annular shelf 68 within the hose coupling 48 as shown in FIG. 4B, at which point the motor 44 may be shut off. Depending on the hose coupling 48, completion of the installation of the hose coupling 48 on the hose 52 may require an additional step to anchor the hose coupling 48 to the hose 52, such as by driving screws through holes in the collar portion 56 into the hose 52. The hose 52 and hose coupling 48 cooperate to provide a media path 72 for media such as sand in a sand blasting application. The annular shelf 68 has an inner diameter equal to the inner diameter of the size of hose 52 for which the hose coupling 48 is designed. As such, when the free end of the hose 52 is properly seated, the media path 72 has a smooth, continuous, cylindrical shape. The ability of the worker to apply mostly axial force on the hose 52 while the tool 10 turns the hose coupling 48 makes proper seating of the free end of the hose 52 against the shelf 68 less difficult to achieve consistently.

During the above described installation process, the tool 10 may be used to turn the hose coupling 48 clockwise about the hose 52 from the perspective of the motor 44.

Clockwise turning cooperates with the direction of internal threading typically present in collar portions 56. However, the hose coupling 48 may instead be turned counter-clockwise during installation if no threading is present in the collar portion 56, or if the collar portion 56 is reverse-threaded. If a hose coupling 48 needs to be removed from a hose 52, the tool 10 can be used to turn the hose coupling 48 in a direction opposite to the direction used to install the hose coupling.

A process 74 for installing a hose coupling 48 on a hose 52 that may be executed with the devices described above is illustrated in FIG. 5. At block 76, beginning the process 74, the drive assembly 38 is prepared. The drive assembly 38 may be prepared well in advance of any particular hose coupling 48 installation, and may be done by a different worker or workers than the remainder of the process 74. At stage 78, blocks 80, 82, and 84 are executed in any order. At block 80, the tool 10 is coupled to the drive assembly 38 through the jaw coupling 36, and at block 82 the hose coupling 48 is placed on the tool 10 so that the hose coupling 48 is aligned on the axis X and the arms 18 abut the hooks 60. At block 84, the hose is prepared by, if necessary, cutting the hose 84 to provide a squared off end. A sealant or glue may also be spread at the squared off end of the hose 52, or within the collar portion 56 of the hose coupling 48. Thus, at the end of stage 78, the hose 52 is prepared for fitting into the hose coupling 48, and the hose coupling 48 is connected to the drive assembly 38 so that output from the motor 44 will rotate the hose coupling 48 about the axis X.

In the illustrated example, the motor 44 is activated in block 86 after stage 78 is completed. It is generally less safe and more difficult for the worker to apply the tool 10 to the jaw coupling 36 while the jaw coupling 36 is rotating, or to apply the hose coupling 48 to the tool 10 while the tool 10 is being driven by the drive assembly 38. Further, letting the motor 44 run while the hose 52 is being prepared wastes energy. However, in other examples, block 86 may instead be executed before, during, or between any of blocks 80, 82, and 84.

After stage 78 and block 86 are complete, the hose 52 is pressed into the collar portion 56 of the hose coupling 48 while the drive assembly 38 turns the tool 10 in block 88. The hose 52 is pressed until it seats against the shelf 68 as described above. After the hose 52 is seated in block 88, the hose coupling 48 is removed from driving engagement with the drive assembly 38 by any one or any combination of removing the hose coupling 48 from the tool 10, removing the tool 10 from the jaw coupling 36, and shutting off the motor 44. When the hose coupling 48 is no longer being rotated, the hose coupling 48 may be fixed to the hose 52 at block 90 if necessary. For example, if the hose coupling 48 includes an array of holes in the collar portion 56, screws may be driven into the hose 52 through the holes 56 to fix a hose coupling 48 to the hose 52.

A tool 110 according to another arrangement is shown in FIGS. 6A-6C. The tool 110 of FIGS. 6A-6C is similar to the tool 10 of FIGS. 1A-5, with like elements indicated by like numerals (i.e., teeth 26 and 126), except for differences in scale or as illustrated in the figures or described below. The arms 118 are longer in proportion to the hub 114 than the arms 18 are to the hub 10 as shown in FIGS. 1A-1C. The tool 110 also lacks a boss 22. Instead, the hub 114 of the tool 110 extends along the axis X beyond axial surfaces of the arms 118 opposite from the teeth 126. The tool 110 is for use with a hose coupling 48 that has an internal diameter matched to an external diameter of the hub 114 in the same way that the internal diameter of the hose coupling 48 matching the external diameter of the boss 22 was described above with regard to FIG. 4A. The hub 114 itself may therefore extend into an opening of a hose coupling 48 opposite from the collar portion 56. A process for using the tool 110 to install a hose coupling 48 on a hose 52 is therefore the same as the process for using the tool 10 described with regard to FIGS. 3A-5, except that engaging the hose coupling 48 to the tool 110 includes inserting the hub 114 partially into the hose coupling 48 instead of the boss 22.

The elongated arms 118 and the extended hub 114 cooperate to make the tool 110 of FIGS. 6A-6C suitable for use with hose couplings 48 that are larger in diameter in proportion to the hub 114 compared to the tool 10 design shown in FIGS. 1A-1C. Because the teeth 126 are sized and spaced to have a collective diameter equal to the diameter of the hub 114, the diameter of the jaw couplings 36 the tool 110 may engage with is proportional to the diameter of the hub 114. Thus, compared to the tool design 10 shown in FIGS. 1A-1C, the tool 110 is also useful for transferring force from a jaw coupling 36 to a hose coupling 48 that is larger in proportion to the jaw coupling 36. For a given jaw coupling 36, tools may therefore be designed for hose couplings 48 of different sizes by increasing or decreasing the lengths of the arms 18, 118 and the diameter of the boss 22, if present, in proportion to the diameter of the hub 14, 114. For hose couplings 48 that have a larger internal diameter than the external diameter of the jaw coupling 36, a disc may be welded onto the hub 14, 114 of a tool 10, 110 to provide the aligning function instead of the boss 20.

The hub 114 also includes a set screw hole 124 aligned with the keyway 122. A set screw may be threaded into the set screw hole 124 to bear on the key and maintain the tool's 110 position on the drive shaft 40. Though not illustrated, the tool 10 of FIGS. 1A-3B may also have a set screw hole in the hub 14 or the boss 22.

The hose coupling mechanism described above is advantageous in that it can allow a worker to install hose couplings on a blast hose more quickly and in greater number without fatigue. By motorizing the rotation of the hose coupling about the hose, the mechanism relieves the worker of the need to repeatedly overcome static friction between the hose coupling and the hose as the worker presses the hose into the collar portion of the hose coupling. With static friction overcome and the hose coupling in continuous rotation, the worker may press the hose to seat properly within the hose coupling with relative ease and consistency.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for installing hose couplings, the system comprising:
a motor;
a drive shaft extending along and axis and powered about the axis by the motor; and
a tool rotationally coupled to the drive shaft, the tool comprising:
a hub; and
two arms extending outward from the hub and defining respective load surfaces such that both arms may tangentially abut a respective hook of a quick coupling for a blast hose when the quick coupling is aligned on the axis.

2. The system of claim 1, further comprising a gear reduction between the motor and the drive shaft.

3. The system of claim 1, wherein the tool is rotationally coupled to the drive shaft through a jaw coupling into which the drive shaft extends.

4. The system of claim 1, wherein the tool includes an extension that constrains the hose coupling onto the axis.

5. The system of claim 4, wherein the extension is a boss with an external diameter smaller than an external diameter of the hub.

6. The system of claim 1, wherein the load surfaces are symmetrical about a point on the axis on a plane perpendicular to the axis that intersects the arms.

7. The system of claim 7, wherein the load surfaces are not collinear on any plane perpendicular to the axis.

8. A tool for installing hose couplings, the tool comprising:
a hub centered on an axis;
two arms extending radially outward from the hub, each including a load surface, the two load surfaces being symmetrical to one another about a point on the axis on a plane perpendicular to the axis that intersects the arms; and
at least two torque coupling surfaces integrally formed with the hub, distinct from the load surfaces, and arranged relative to the axis such that torque about the axis may be imparted to the hub by simultaneous application of force to the torque coupling surfaces.

9. The tool of claim 8, further comprising teeth extending axially from the hub and defining the torque coupling surfaces.

10. The tool of claim 9, wherein the teeth are three teeth for engagement with a jaw coupling.

11. The tool of claim 8, further comprising an axial extension from the hub that can constrain a hose coupling onto the axis.

12. The tool of claim 11, wherein the torque coupling surfaces are defined on features extending in an opposite axial direction from the hub than the extension.

13. The tool of claim 11, wherein the extension is a boss having a smaller external diameter than an external diameter of the hub.

14. The tool of claim 8, including an axial bore extending through the hub.

15. A method of installing a hose coupling onto a hose, the method comprising pressing the hose into a hose receiving end of the hose coupling while a motorized source of torque rotates the hose coupling.

16. The method of claim 15, wherein the hose coupling is rotationally driven by the motorized source of torque through a drive shaft driven by the motorized source of torque and a tool rotationally coupling the hose coupling to the drive shaft, the tool comprising:
a hub; and
two arms extending outward from the hub and defining respective load surfaces such that both arms may tangentially abut a respective hook of a quick coupling for a blast hose when the quick coupling is aligned on the axis.

17. The method of claim 16, further comprising coupling teeth of the tool to a jaw coupling rotationally coupled to the drive shaft before pressing the hose into the hose receiving portion of the hose coupling.

18. The method of claim 16, further comprising aligning the hose coupling on an axis of rotation of the drive shaft and positioning the hose coupling relative to the tool such that the arms each abut a hook extending from the hose coupling.

19. The method of claim 18, wherein the step of aligning the hose coupling on the axis includes sliding the hose coupling onto an extension from the hub.

20. The method of claim 19, wherein the extension from the hub is a boss having an external diameter that is less than an external diameter of the hub.
